(19) United States
(12) Patent Application Publication
(10) Pub. No.: US 2014/0060274 A1
(43) Pub. Date: Mar. 6, 2014

(54) Cutting Apparatus for Glass Substrate and Method of Cutting the Glass Substrate

(71) Applicants: Minghu Qi, Shenzhen (CN); Chunhao Wu, Shenzhen (CN); Kunhsien Lin, Shenzhen (CN); Yongqiang Wang, Shenzhen (CN); Xiande Li, Shenzhen (CN); Zhenhua Guo, Shenzhen (CN)

(72) Inventors: Minghu Qi, Shenzhen (CN); Chunhao Wu, Shenzhen (CN); Kunhsien Lin, Shenzhen (CN); Yongqiang Wang, Shenzhen (CN); Xiande Li, Shenzhen (CN); Zhenhua Guo, Shenzhen (CN)

(73) Assignee: SHENZHEN CHINA STAR OPTOELECTRONICS TECHNOLOGY CO, LTD., Shenzhen (CN)

(21) Appl. No.: 13/641,100

(22) PCT Filed: Sep. 4, 2012
(86) PCT No.: PCT/CN12/80957

§ 371 Date: Oct. 13, 2012

(30) Foreign Application Priority Data
Aug. 31, 2012 (CN) 201210316778.4

(51) Int. Cl. B26F 3/00; B24C 3/32

(52) U.S. Cl. 83/53; 83/177; 451/75

(57) ABSTRACT

The present invention provides a cutting apparatus for cutting glass substrate which comprises a cutting device including a first waterjet and a second waterjet. A compressed liquid source is in communication with the first and second waterjet. And a first controlling unit is used to control the operation of the first and second waterjets. The present invention also relates to a method for cutting the glass substrate. By the provision of the present invention, the performance of cutting the glass substrate is increased, and the cost is reduced.

### FIELD OF THE INVENTION

The present invention relates to a field of manufacturing of liquid crystal display device, and more particularly to a cutting apparatus for glass substrate and also a method for cutting the glass substrate.

### DESCRIPTION OF PRIOR ART

The manufacturing of the liquid crystal display panel can be divided into three different stages, i.e. a first process of arranging Array, a second process of making Cell, and the last process of integrating of liquid crystal display module. In the second process of making Cell, a glass substrate from the first process is combined with other colorful filters, and then refilling liquid crystal into the substrate. After the refilling process, the substrate is undergoing cutting process to designated dimensions.

Currently, the glass substrate is separated by cutting wheel to the designated dimensions. However, during the cutting process, the cutting edge of the cutting wheel is very sharp, and as it is rotated in very high speed, the wearing of the cutting edge makes it to be replaced frequently. This inevitably increases the manufacturing cost, while lowering the yield of the production.

### SUMMARY OF THE INVENTION

It is the primary purpose of the present invention to provide a cutting apparatus for glass substrate, and also a method for cutting the glass substrate so as to increase the performance of cutting the glass substrate, and also lower the manufacturing cost.

In order to resolve the technical issue encountered by the prior art, the present invention provides a technical solution by introducing a cutting apparatus for cutting glass substrate which comprises a cutting device including a first waterjet and a second waterjet. A compressed liquid source is in communication with the first and second waterjet. And a first controlling unit is used to control the operation of the first and second waterjets.

Wherein the cutting apparatus includes a second controlling unit regulating the flow and pressure of the compressed liquid source.

Wherein the second controlling unit is a valve.

Wherein the compressed liquid source is blended with grinding agent.

In order to resolve the technical issue encountered by the prior art, the present invention provides a technical solution by introducing a method for cutting glass substrate which comprises the steps of a) providing a first controlling unit making a first waterjet and a second waterjet being arranged on two opposite ends of a predetermined cutting line; b) driving simultaneously the first and second waterjets to move toward each other along the cutting line; c) stopping the advancement of the first waterjet at a preset stopping position, while keep moving the second waterjet to advance cutting along the cutting line till the second waterjet reaches to the preset stopping position so as to complete the cutting; and d) wherein the first and second waterjets are located on opposite sides of the glass substrate, and the preset stopping position is substantially located at a center of the predetermined cutting line, while a little more closer to the first waterjet.

Wherein the first controlling unit includes a positioning device of charge-couple device so as to correctly position the first and second waterjets in a way that cutting traces left by the first and second waterjets is inline with each other.

Wherein the glass substrate is positioned horizontally.

In order to resolve the technical issue encountered by the prior art, the present invention provides a technical solution by introducing a method for cutting glass substrate which comprises the steps of a) providing a first controlling unit making a first waterjet and a second waterjet being arranged on two opposite ends of a predetermined cutting line; b) driving simultaneously the first and second waterjets to move toward each other along the cutting line; and c) stopping the advancement of the first waterjet at a preset stopping position, while keep moving the second waterjet to advance cutting along the cutting line till the second waterjet reaches to the preset stopping position so as to complete the cutting.

Wherein the first and second waterjets are located on opposite sides of the glass substrate.

Wherein the first and second waterjets are arranged on the same side of the glass substrate, wherein the first waterjet is stopped at a preset stopping position, and then moved back so as to prevent an interference with the second waterjet.

Wherein the preset stopping position is substantially located at a center of the predetermined cutting line, while a little more closer to the first waterjet.

Wherein the first controlling unit includes a positioning device of charge-couple device so as to correctly position the first and second waterjets in a way that cutting traces left by the first and second waterjets is inline with each other

Wherein the glass substrate is positioned horizontally.

With the provision and disclosure of the present invention, the first and second waterjets are controlled by the first controlling unit in a way that the first and second waterjets are arranged on opposite ends of a cutting line. The first and second waterjets are driven to move simultaneously along the cutting line. The first waterjet is stopped at a preset stopping position, and the second waterjet will proceed to complete the cutting. There is no physical contact between the first and second waterjets, as a result, there is no worn on the waterjets. The cutting performance of the cutting is therefore increased, the cost is therefore reduced.

### BRIEF DESCRIPTION OF DRAWINGS

FIG. 1 is a illustrational and structural of a cutting apparatus for glass substrate made in accordance with the present invention;

FIG. 2 is a perspective view of the cutting apparatus shown in FIG. 1;

FIG. 3 is a side elevational view of the cutting apparatus shown in FIG. 2;

FIG. 4 is an illustrational view of the cutting apparatus of FIG. 2 stopped at a preset stopping position; and

FIG. 5 is a flow diagram of a cutting method made in accordance with the present invention.

### DETAILED DESCRIPTION OF PREFERRED EMBODIMENT

Detailed description will be given in view of the embodiment along with the accompanied drawings.

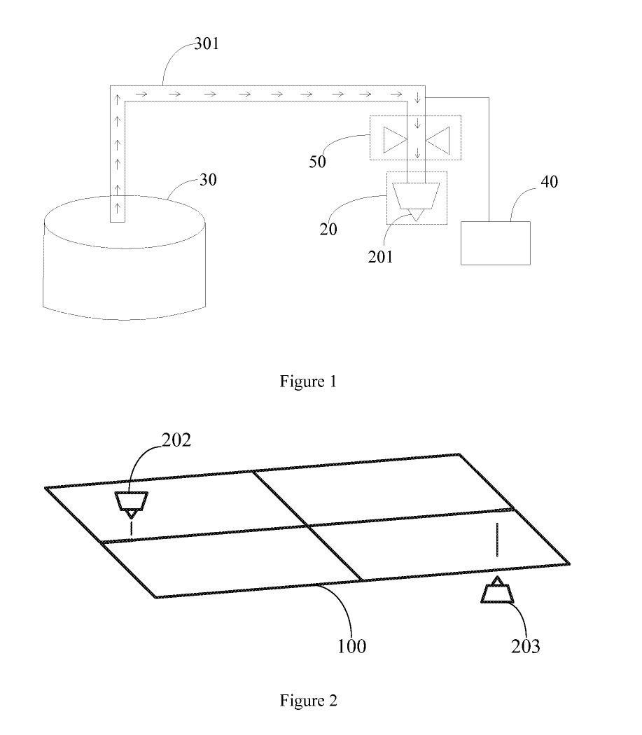

Referring to FIGS. 1 and 2, in which FIG. 1 is a illustrational and structural of a cutting apparatus for glass substrate made in accordance with the present invention; and FIG. 2 is a perspective view of the cutting apparatus shown in FIG. 1. As it can be clearly seen, a glass substrate 100 is also clearly described in FIG. 2. The cutting apparatus includes a cutting device, a compressed liquid source 30, and a first controlling unit 40.

The cutting device 20 includes a first waterjet 202 and a second waterjet 203. Each of the first and second waterjets 202, 203 includes a cutting nozzle 201 which is made from hard alloy, sapphire, and ruby. The orifice of the nozzle is very small, and such as 0.05 mini meters.

The compressed liquid or water resource 30 supplies the compressed water to the first waterjet 202 and the second waterjet 203. It should be noted that in other embodiments, the compressed water 30 can be implemented with other compressed liquid and there is no limitation on this respect. The velocity of the jet stream coming out of the waterjet is extremely high, and the pressure out of the nozzle 201 could reach 1700 MPa. According, the momentum thereof can readily cutting through the glass substrate. It should be noted that the jet stream is also blended with grinding agent, such as garnet powder and diamond powder. With these grinding agents of high hardness and cutting power, the glass substrate can be readily cut through. The compressed water resource 30 further includes a conduit 301 which is used to supply the compressed liquid to the first waterjet 202 and the second waterjet 203.

The first controlling unit 40 is used to operate the first waterjet 202 and the second waterjet 203. The first controlling unit 40 can regulate the speed, direction, stop and run of the first and second waterjets 202, 203 such that the first and second waterjets 202, 203 can be used to precisely to cut the glass substrate. The first controlling unit 40 further includes a driving unit and a Charge-coupled Device (CCD) (not shown). In the preferred embodiment, the driving unit is a motor, and it can be readily appreciated that other driving device can also be incorporated to drive and operate the first and second waterjets 202, 203. As a result, no limitation is imposed thereof.

The cutting apparatus made according to the present invention further includes a second controlling unit 50 which is used to regulate the flow and pressure of the jet stream from the nozzle. The flow and pressure of the jet stream can be readily and effectively regulated according to different work piece or glass substrate in view of their thickness and material. In the current embodiment, the second controlling unit 50 is a valve which can be readily manipulated manually or automatically.

According to the current embodiment, the cutting apparatus conducts its cutting process through the use of the first and second waterjets ejecting compressed liquid flow toward the glass substrate. Since there is no physical contact between the first and second waterjets and the glass substrate, the service life of the cutting apparatus can last longer as compared to those cutting wheel. As a result, the manufacturing cost is therefore reduced.

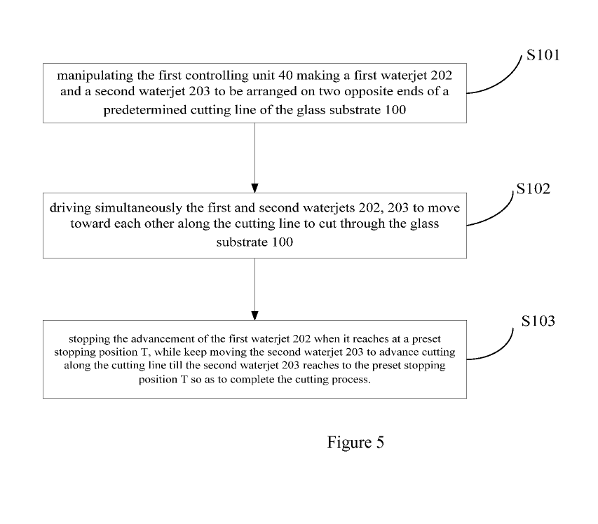

Referring to FIG. 5 which is a flow diagram of a cutting method made in accordance with the present invention.

Step S101: manipulating the first controlling unit 40 making a first waterjet 202 and a second waterjet 203 to be arranged on two opposite ends of a predetermined cutting line of the glass substrate 100;

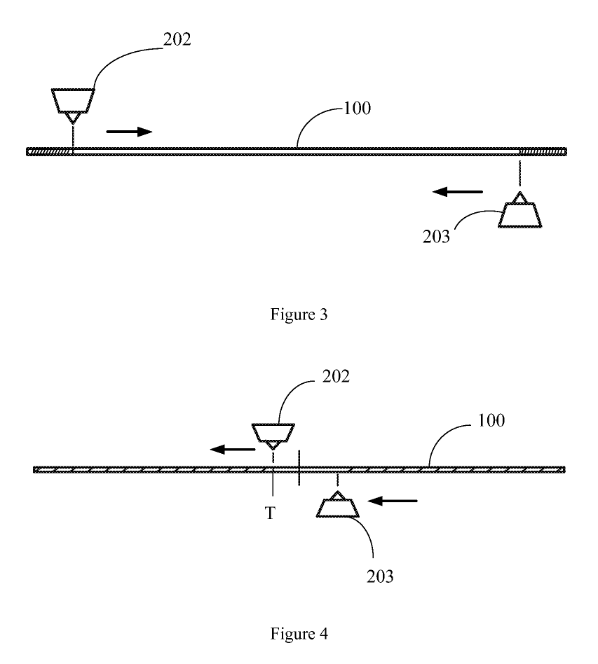

Referring to FIG. 3 which is a side elevational view of the cutting apparatus shown in FIG. 2. In the current embodiment, the glass substrate 100 is arranged and positioned horizontally. Of course, without negatively influenced the cutting process, the glass substrate 100 can be arranged in other position, which will not be limited herewith. The first waterjet 202 and the second waterjet 203 can be arranged on the opposite sides of the glass substrate, or on the same side. The first and second waterjets 202, 203 can be precisely positioned by the CCD such that the cutting traces from the first and second waterjets 202 and 203 are aligned with each other.

Step S102: driving simultaneously the first and second waterjets 202, 203 to move toward each other along the cutting line to cut through the glass substrate 100;

Step S103: stopping the advancement of the first waterjet 202 when it reaches at a preset stopping position T, while keep moving the second waterjet 203 to advance cutting along the cutting line till the second waterjet 203 reaches to the preset stopping position T so as to complete the cutting process.

Referring to FIG. 4 which is an illustrational view of the cutting apparatus of FIG. 2 stopped at a preset stopping position. According to the embodiment, the preset stopping position T is located substantially at a center, but a little be closer to the first waterjet 202. However, it can be readily understood that the stopping position T can be readily set according to the field requirements. As a result, no limitation should be imposed on this. When the first waterjet 202 reaches to the stopping position T, the operation of the first waterjet 202 will be automatically shutoff. Furthermore, the first waterjet 202 will be moved backward so as to prevent an interference with the second waterjet 203 which will continue to proceed to complete the cutting. It should be noted that the first and second waterjets 202, 203 are identical, and the first and second are merely designated for readily description. It should be noted that the position of the first and second waterjets 202 and 203 can be switched from each other, while it will not impose any limitation to the present invention.

With the provision and disclosure of the present invention, the first and second waterjets are controlled by the first controlling unit in a way that the first and second waterjets are arranged on opposite ends of a cutting line. The first and second waterjets are driven to move simultaneously along the cutting line. The first waterjet is stopped at a preset stopping position, and the second waterjet will proceed to complete the cutting. The cutting performance of the cutting is therefore increased, the cost is therefore reduced.

The above described is merely a primary disclosure. In order to readily clarify the technical solution, and therefore implement that technical solution in view of the specification, a detailed description in view of a preferable embodiment in conjunction with accompanied drawings will be given herebelow. By this, other purposes, features and characteristics can be readily appreciated through the detailed description.

1. A cutting apparatus for cutting glass substrate, comprising:
a cutting device including a first waterjet and a second waterjet;
a compressed liquid source in communication with the first and second waterjet; and
a first controlling unit used to control the operation of the first and second waterjets.

2. The cutting apparatus as recited in claim 1, wherein the cutting apparatus includes a second controlling unit regulating the flow and pressure of the compressed liquid source.

3. The cutting apparatus as recited in claim 2, wherein the second controlling unit is a valve.

4. The cutting apparatus as recited in claim 1, wherein the compressed liquid source is blended with grinding agent.

5. A method for cutting glass substrate, comprising the steps of:
a) providing a first controlling unit making a first waterjet and a second waterjet being arranged on two opposite ends of a predetermined cutting line;
b) driving simultaneously the first and second waterjets to move toward each other along the cutting line;
c) stopping the advancement of the first waterjet at a preset stopping position, while keep moving the second waterjet to advance cutting along the cutting line till the second waterjet reaches to the preset stopping position so as to complete the cutting; and
d) wherein the first and second waterjets are located on opposite sides of the glass substrate, and the preset stopping position is substantially located at a center of the predetermined cutting line, while a little more closer to the first waterjet.

6. The cutting method as recited in claim 5, wherein the first controlling unit includes a positioning device of charge-couple device so as to correctly position the first and second waterjets in a way that cutting traces left by the first and second waterjets is inline with each other.

7. The cutting method as recited in claim 5, wherein the glass substrate is positioned horizontally.

8. A method for cutting glass substrate, comprising the steps of:
a) providing a first controlling unit making a first waterjet and a second waterjet being arranged on two opposite ends of a predetermined cutting line;
b) driving simultaneously the first and second waterjets to move toward each other along the cutting line; and
c) stopping the advancement of the first waterjet at a preset stopping position, while keep moving the second waterjet to advance cutting along the cutting line till the second waterjet reaches to the preset stopping position so as to complete the cutting.

9. The cutting method as recited in claim 8, wherein the first and second waterjets are located on opposite sides of the glass substrate.

10. The cutting method as recited in claim 8, wherein the first and second waterjets are arranged on the same side of the glass substrate, wherein the first waterjet is stopped at a preset stopping position, and then moved back so as to prevent an interference with the second waterjet.

11. The cutting method as recited in claim 8, wherein the preset stopping position is substantially located at a center of the predetermined cutting line, while a little more closer to the first waterjet.

12. The cutting method as recited in claim 8, wherein the first controlling unit includes a positioning device of charge-couple device so as to correctly position the first and second waterjets in a way that cutting traces left by the first and second waterjets is inline with each other.

13. The cutting method as recited in claim 8, wherein the glass substrate is positioned horizontally.
